(19) United States
(12) Patent Application Publication
(10) Pub. No.: US 2025/0006887 A1
(43) Pub. Date: Jan. 2, 2025

(54) SYSTEM AND METHODS RELATING TO INTERPENETRATING MULTI-ELECTRODES AND FABRICATION THEREOF FOR ELECTROCHEMICAL DEVICES

(71) Applicant: Lawrence Livermore National Security, LLC, Livermore, CA (US)

(72) Inventors: Nikola DUDUKOVIC, Hayward, CA (US); Auston Louis CLEMENS, Livermore, CA (US); Swetha CHANDRASEKARAN, Livermore, CA (US); Marcus A. WORSLEY, Hayward, CA (US)

(21) Appl. No.: 18/217,259

(22) Filed: Jun. 30, 2023

(51) Int. Cl. H01M 4/133; B33Y 10/00; B33Y 80/00; H01M 4/04; H01M 4/134; H01M 4/1393; H01M 4/1395; H01M 4/36; H01M 4/38; H01M 4/583

(52) U.S. Cl. CPC H01M 4/133; B33Y 10/00; B33Y 80/00; H01M 4/0411; H01M 4/045; H01M 4/0471; H01M 4/134; H01M 4/1393; H01M 4/1395; H01M 4/366; H01M 4/38; H01M 4/583

(57) ABSTRACT

The present disclosure relates to a multi-electrode electrochemical apparatus. In one embodiment the apparatus has a first beam-like structure having a first material coating, with the first beam-like structure forming a first electrode. A second structure is included which has a second material coating. The second structure forms a second electrode. The first and second structures are further configured in an interpenetrating fashion within a defined 3D space to form an electrochemical apparatus, and without physical contact at any point within the defined 3D space.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to electrochemical devices, and more particularly to systems and methods for forming interpenetrating multi-electrodes and fabrication thereof which are well adapted for use in electrochemical devices.

### BACKGROUND

The statements in this section merely provide background information related to the present disclosure and may not constitute prior art.

Electrochemical devices can generate electrical energy from chemical reactions, or carry out chemical reactions by applying an electric field. At minimum, these reactors consist of two oppositely charged electrodes (anode and cathode) with a liquid or solid electrolyte in between. However, most reactors are limited to simple electrode configurations, where the macroscopic shapes of the working electrodes are typically flat sheets (although they can be solid or porous), spaced apart by a certain distance. In some cases, the working electrode is a solid sheet or a porous mesh, while the counter electrode is a simple wire or sheet.

The above-described simple electrode configurations impose fundamental limitations to an electrochemical device. Such limitations involve non-uniformities in the electric field, energy losses due to mass transport resistances, unknown stochastic geometries, limited volumetric form factors, etc.

What is needed then are new electrode structures and configurations that do not suffer from the drawbacks of presently manufactured electrodes. This invention leverages computer aided design and advanced manufacturing to produce previously unachievable configurations by having two or more continuous electrode structures intertwining in 3D space, providing improved control electric field uniformity, the ability to carry out multiple electrochemical reactions, and an expanded design space for electrochemical devices.

### SUMMARY

This section provides a general summary of the disclosure, and is not a comprehensive disclosure of its full scope or all of its features.

In one aspect the present disclosure relates to a multi-electrode electrochemical apparatus. The apparatus may comprise a first beam-like structure having a first material coating, with the first beam-like structure forming a first electrode. The apparatus may further include a second structure having a second material coating, with the second structure forming a second electrode. The first and second structures are configured in an interpenetrating fashion within a defined 3D space to form an electrochemical apparatus, and without physical contact at any point within the defined 3D space.

In another aspect the present disclosure relates to a method for forming a multi-electrode electrochemical apparatus using an additive manufacturing system. The method may comprise printing first and second structures such that the first and second have portions thereof which form an interpenetrating configuration within a defined 3D volume, and without physically contacting one another within the defined 3D volume. The method may further include plating the first and second structures with first and second materials, respectively.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

Corresponding reference numerals indicate corresponding parts throughout the several views of the drawings.

FIG. 1 is a high level block diagram of one additive form of manufacturing system for producing structures in accordance with the present disclosure;

FIG. 2 is a perspective view of one example of an interpenetrating, beam-like lattice structure of the present disclosure, showing in perspective separate illustrations each of the electrodes that are used to form the structure;

FIG. 3 is an illustration of a beam-like interpenetrating lattice structure, together with separate illustrations show how the structure appears after being pyrolyzed and then plated with different materials;

FIG. 4 is an illustration of a interpenetrating gyroid having two electrodes, with separate illustrations showing how the structure appears when initially AM printed from a polymer, and the pyrolyzed to form a carbon structure; and then plated to form a finished coin cell;

FIG. 5 is a perspective illustration showing a 3-electrode, interpenetrating beam-like structure, with a separate illustration to better show, in highly enlarged fashion, the single linear electrode and the two spiral-like electrodes that wrap around the beam linear electrode;

FIG. 6 is a perspective illustration of a beam and wall-based 3-electrode design with separate illustrations showing the two beam-like lattice structures forming two of the electrodes, and a separate perspective illustration showing just a gyroid-like triply periodic minimal surface within which the two electrodes beam-like lattice structures are integrated; and

FIG. 7 is a high level flowchart showing one example of various operations that may be carried out to create a beam-like lattice structure which forms two electrodes.

### DETAILED DESCRIPTION

Example embodiments will now be described more fully with reference to the accompanying drawings.

The present disclosure leverages computer aided design and advanced manufacturing to produce previously unachievable configurations by having two or more continuous electrode structures intertwining in 3D space, but without making physical contact at any point. Such configurations provide a number of benefits over traditionally manufactured electrodes. The electrodes and methods of producing electrodes described herein improve the performance of an electrochemical device in a number of important ways including, but not limited to, improving control electric field uniformity, improving the ability to carry out multiple electrochemical reactions, and improving an expanded design space for electrochemical devices.

The present disclosure further utilizes present day design tools to create architected materials such as beam-based lattices, triply periodic minimal surfaces (TPMS), or other architectures with repeating structural motifs. The teachings presented herein enable the creation of interpenetrating structures with high surface area per volume. By “interpenetrating” it is meant that portions of at least two 3D structures engage with one another in 3D space to create an intertwined or interwoven structure in 3D space but without necessarily physically penetrating or impinging the other, and without coming in physical contact with one another. The electrode structures disclosed herein are in various forms econtinuous and intertwine in space while maintaining either a constant or controlled distance between, but never come in direct contact with each other (i.e. no short-circuiting can occur). The structures can be produced using additive manufacturing or 3D printing methods, as well as combined with other advanced fabrication approaches, such as various heat treatment processes and chemical, physical, or electrochemical deposition methods. The present disclosure provides examples in which interpenetrating architectures were designed and 3D printed using projection microstereolithography (PuSL), a layer-by-layer photopolymerization technique. The polymer structure can be subsequently pyrolyzed to produce an electrically conductive carbon structure. Because the continuous interpenetrating conductive structures are not connected electrically, each can further be independently functionalized using electrodeposition, where a metal (e.g., desired catalyst) or other coating is deposited on one structure, while the other serves as the counter-electrode, and vice versa. Alternatively, a conductive layer can be deposited onto the printed polymer structure (e.g., using electroless deposition, dip coating, etc.) and used directly or further electroplated with the materials of choice as described previously. Another approach is to produce the initial structure from a conductive material directly. For example, methods such as selective laser melting/sintering (SLM/SLS), direct energy deposition (DED), or binder jet printing can produce metallic structures that can be used directly or further electroplated with the materials of choice as described previously.

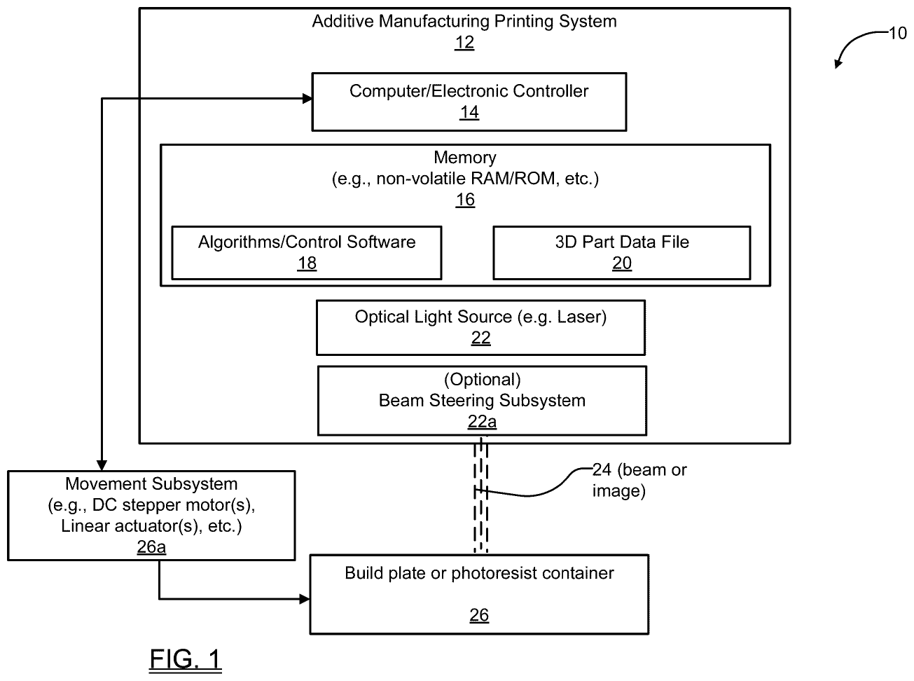

FIG. 1 shows one example of a system 10 that may be used to make the interpenetrating structures disclosed herein. This is but one example, and it will be appreciated that the disclosed 3D structures may be constructed using other additive manufacturing processes as well. The system 10 in this example includes an additive manufacturing (AM) printing system 12 having an computer or electronic controller 14 (hereafter simply “computer” 14). The computer 14 may include or be in communication with a memory 16 (e.g., RAM/ROM, etc.). The memory 14 may store software 18 which includes algorithms and control software for carrying out the AM printing operation. The memory 16 may also include a 3D part data file with data for manufacturing or more specific parts, as well as G-code, etc. An optical light source 22 may be controlled by the computer 14 to generate a beam or image 24. The beam or image 24 may be directed toward a build plate or photoresist container 26. Optionally, depending on the type of AM printing system being used, a beam steering subsystem 22a may be included to scan the beam as needed over the over the feedstock material (e.g., supported on a build plate) being used to print a 3D part. The beam steering subsystem, if employed, maybe controlled by the computer 14 or by a separate independent controller. One or more focusing lenses or other optical components (not shown) may also be included for assisting in focusing the beam or image. Optionally, a movement subsystem 26a may also be employed, which will depend on what type of AM system is being used. The movement control subsystem 26a, if employed, may be used to move the build plate or photoresist container 26, and may include one or more DC stepper motors, linear actuators or any other suitable components for controlling movement of the build plate or photoresist container 26 in a highly controlled fashion within X, Y and Z axes. The system 12 may form a Selective Laser Sintering (SLS) AM system, a micro photostereolithography AM system, a Direct Ink Write (DIW) AM system, or other form of AM system, or any other form of AM system.

It will be appreciated that the foregoing has been a high level description of an AM system suitable for producing the interpenetrating structures disclosed herein. The assignee of the present application is a leader in AM manufacturing technology, and the disclosures of the following patents and published U.S. patent applications, all owned by the assignee of the present disclosure, are hereby incorporated by reference in the present application: U.S. Pat. Nos. 9,308,583; 9,855,625; 10,569,363; 11,534,865; US 2023/0123528; U.S. Pat. Nos. 10,647,061; 11,370,173; US 2022/0212414; US 2016/0303797; U.S. Pat. No. 11,312,067; US 2023/0076771; U.S. Pat. Nos. 10,376,987; and 11,524,458.

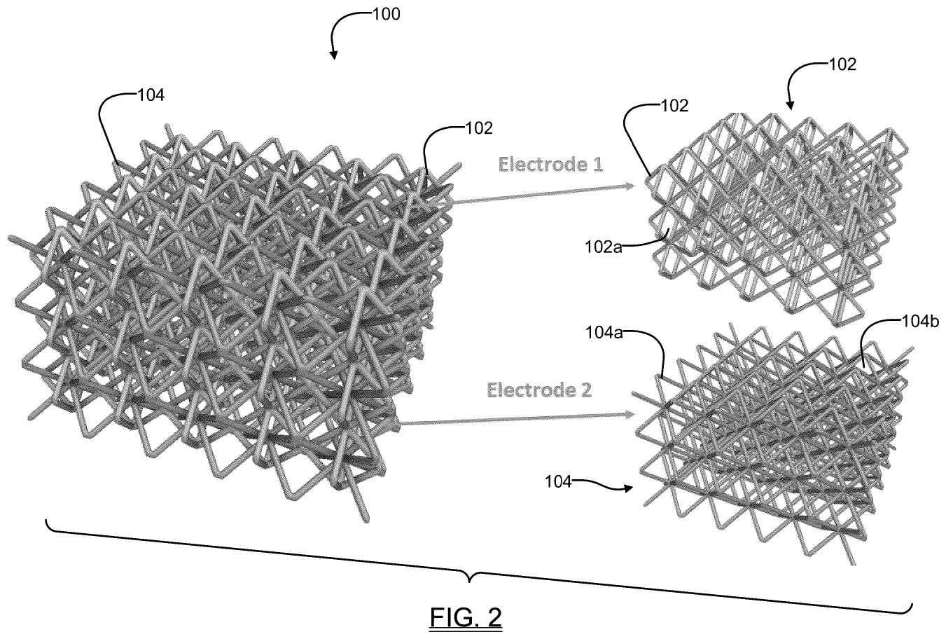

Referring to FIG. 2, one example of a two electrode interpenetrating lattice structure 100 is shown. The structure 100 in this example is constructed using any suitable AM manufacturing system, such as disclosed herein, and includes a first electrode 102 and a fully independent second electrode 104. By “fully independent” it is meant the second electrode 104 is formed fully independently of the first electrode 102 and is not in physical contact with the first electrode at any point within the volume of the structure 100. The electrodes 102 and 104 each form lattice-like structures that may intersect one another in a uniform, repeating manner throughout an overall 3D volume of the structure 100. The first electrode 102 is formed by a plurality of interlinked struts 102a which create cells 102b that propagate in a 3D space in a triply periodic fashion. The second electrode 104 similarly includes a plurality of interlinked struts 104a that form cells 104b that propagate in 3D space in a triply periodic fashion. In this example the struts 102a and 104a create interlinked cells 102a and 104a throughout the 3D volume of the structure in a uniform, triply periodic fashion, but where no ones of the struts 102a and 104a physically contact one another. So the two electrodes 102 and 104 are electrically and physically isolated from one another.

The dimensions of the struts 102a and 104a may vary significantly to suit a specific application, but in one embodiment typically will have a diameter of between about 50-μm-500 μm. It will also be appreciated that this dimension will typically be dependent on the size of the part being printed. Parts made with struts within the above-mentioned range will typically be roughly about 1×2×2 cm. The struts can be larger in diameter if the overall size of the part is larger, and conversely the struts can be smaller if the overall size of the part is smaller. Ultimately, if the struts 102a/104a maintain a suitable or proper separation between one another, the diameters can vary significantly. Therefore, it should also be appreciated that the diameters of the two struts 102a and 104a need not be the same, and the dimensions of the cells created by the struts 102a and 104a need not be same, although in this example they are. The length of each strut 102a and 104a likewise may vary, but in some embodiments may be between about 50 μm to 500 μm. The cells 102b and 104b in this example are generally square in shape, although they could assume other shapes, as will be apparent from the following discussion. In one example the electrodes are formed from polymer during the AM printing process (e.g., via microstereolithography or other process), and may be subsequently subjected to other processes such as heat treatment or pyrolization, as well as processes such as chemical, physical or electrochemical deposition processes, or even subtractive processes.

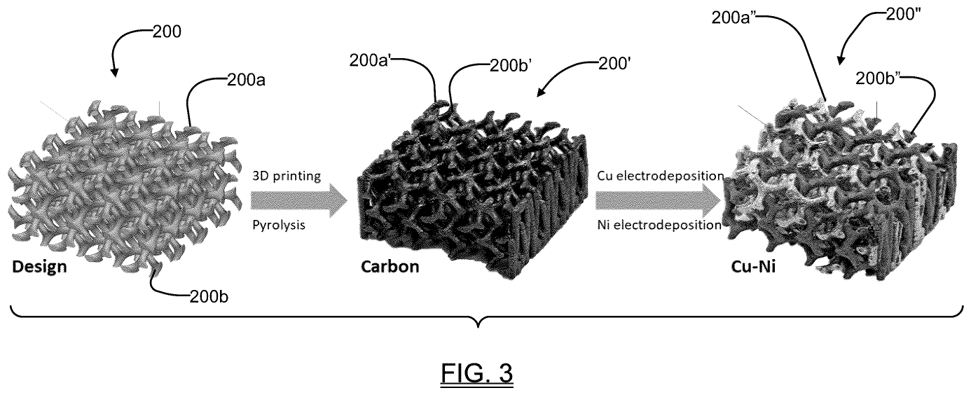

FIG. 3 illustrates perspective views of a 3D printed, interpenetrating lattice structure 200 as the structure undergoes subsequent processes to produce an electrochemical structure. The structure 200 has two fully independent, interpenetrating, beam-like lattice structures 200a and 200b which have been AM printed from a polymer. The beam-like lattice structures 200a and 200b are not in physical or electrical contact at any point.

The structure 200 is then pyrolyzed to produce an interpenetrating, beam-like lattice, electrically conductive carbon structure 200′ having beam-like lattice structures 200a′ and 200b′. Because the two beam-like lattice structures 200a′ and 200b′ are not physically or electrically connected at any point, they can be further functionalized. The beam-like lattice structures 200a′ and 200b′ are plated through one or more electrodeposition processes to produce an electromechanical structure 200″. In this example the electromechanical structure 200″ has the beam-like lattice structure 200a′ plated with one material, for example copper (Cu) to form one beam-like lattice electrode 200a″, while the other beam-like lattice structure 200b′ is plated with a different material, for example nickel (Ni). The platings may be accomplished through an electrodeposition process or through any other suitable process. With the finished electromechanical structure 200″ one of the beam-like lattice structures 200a″ or 200b″ forms an electrode and the other forms a counter-electrode. In another embodiment the electrically conductive layer can be deposited onto one of the beam-like lattice structures 200a or 200b by the printed polymer structure 200 by electroless deposition, dip coating or other means, and then optionally further electroplated with materials of choice. In still another embodiment the beam-like lattice structures 200a and 200b are not produced from polymer but rather directly from one or more metals, for example through AM manufacturing processes such as Selective Laser Sintering (“SLS”), Selective Laser Melting (“SLM”), Direct Energy Deposition (“DED”), Binder Jet Printing, etc. The metal beam-like lattice structures may then be further electroplated with materials of choice to suit a specific application.

In the example embodiment of FIG. 3, the structure 200 was fabricated by 3D-printing a CAD design using large area projection microstereolithography (LAPuSL) (see, e.g., U.S. Patent Pub. No. 2016/0303797 to Moran, assigned to the assignee of the present disclosure, and hereby incorporated by reference into the present disclosure as noted above). The printed polymer part was subsequently pyrolyzed by ramping up to 1000° C. to produce an electrically conductive carbon structure. The two electrode structures 200a′ and 200b′ were connected by wires to a potentiostat and the electroplating reaction was carried out using a copper ion solution.

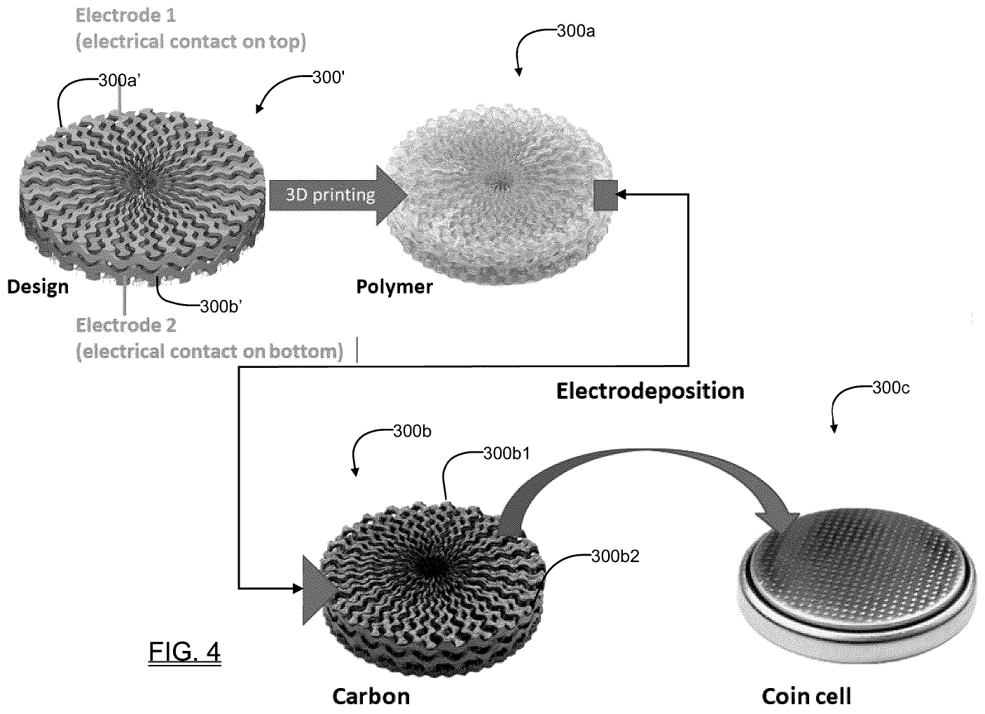

Referring now to FIG. 4, a series of illustrations show the design and fabrication of an interpenetrating cylindrical gyroid 2-electrode system 300′ for forming a standard coin cell battery 300c. The gyroid 2-electrode system 300′ includes a first electrode 300a′ and a second electrode 300b′ which propagate radially outwardly from an axial center. The two electrodes 300a′ and 300′b in this example are shaped complementary to one another such that they fit relatively close to each other but still do not physically touch at any point. The system 300′ in this example is formed first by AM printing the structure from a polymer to produce an interpenetrating, cylindrical gyroid 2-electrode polymer structure 300a. The polymer structure 300a with its two carbon interpenetrating electrodes 300b1 and 300b2 may then be pyrolyzed to produce a carbon, interpenetrating, cylindrical gyroid 2-electrode structure 300b. Electrodeposition operations may then be performed to plate the two electrodes to form sides 300c1 and 300c2 of a coin battery cell 300c.

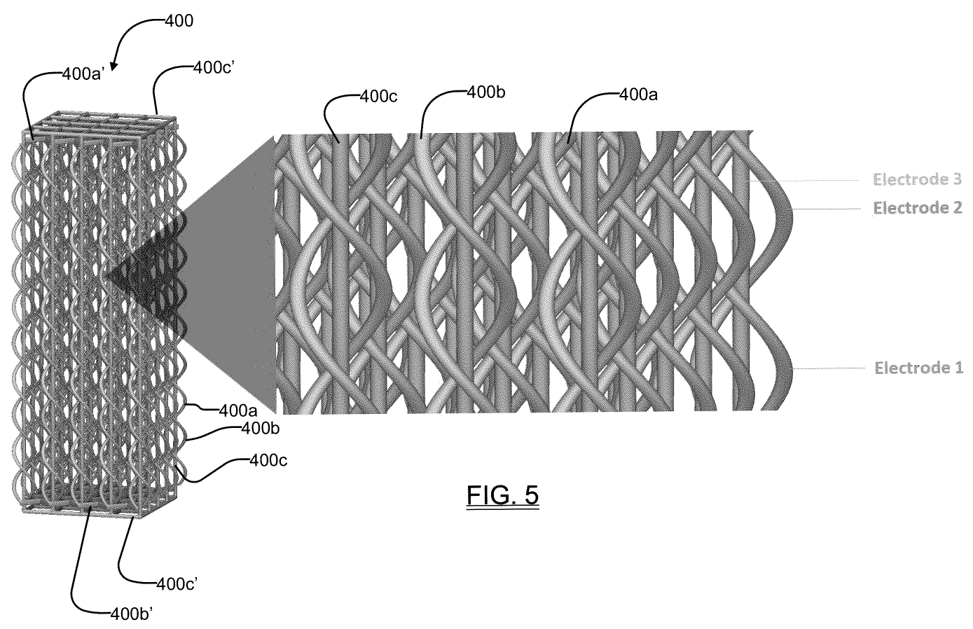

Referring now to FIG. 5, another embodiment of the present disclosure is illustrated in the form of an AM printed, beam-based, 3-electrode structure 400. The beam-based 3-electrode structure 400 in this example includes electrodes 400a, 400b and 400c. Electrodes 400c form an 2D X/Y grid of rod-like elements arranged with equidistant spacing, although they need not be equidistant. The electrodes 400c all extend parallel to one another in this example. Electrodes 400a and 400b forming rod-like, uniformly spiral, interweaving elements that wrap around the electrodes 400a over substantially their full lengths. None of the electrodes 400a, 400b or 400c physically contact one another at any point. The electrodes 400c are interconnected at each of their opposing ends by integrally formed connecting portions 400c′, while electrodes 400b are similarly interconnected at each of their opposing ends by integrally formed connecting portions 400b′, and while electrodes 400a are likewise connected by connecting portions 400a′. It will also be appreciated that while the three electrodes have been incorporated into the structure 400, that a greater or lesser number of electrodes could be incorporated. One or more, or possibly all, of the above-mentioned AM printing processes may be used to 3D print the structure 400.

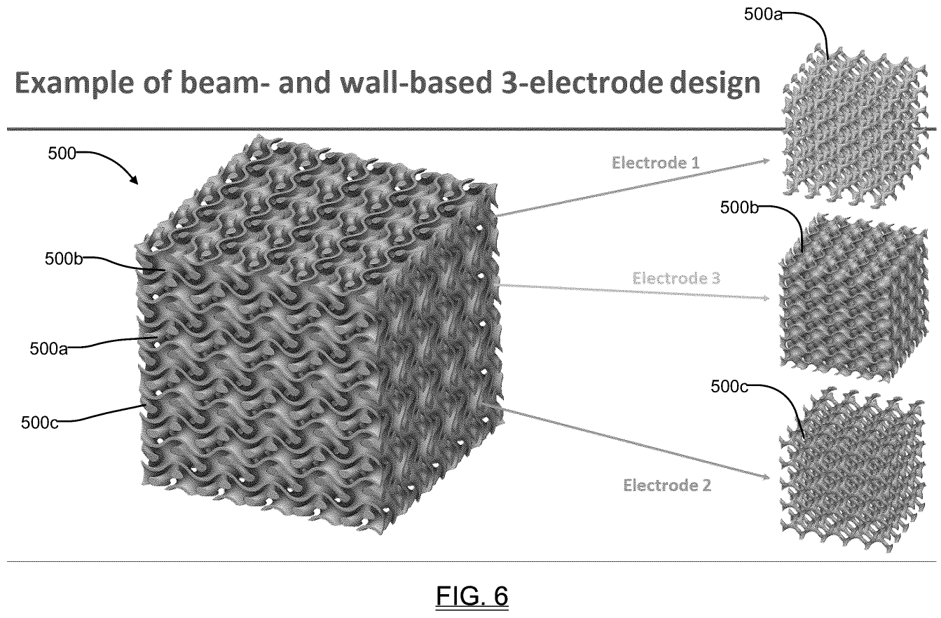

Referring now to FIG. 6, one example of a beam-and-wall based 3-electrode structure 500 is shown. The 3-electrode structure 500 in this example includes a triply periodic minimal a first electrode 500a formed as a beam-like lattice structure propagating in uniformly in 3D space. A second electrode 500b is formed by a wall-based gyroid-like triply periodic minimal surface. A third electrode 500c is a beam-like structure of interconnecting beams that is complementary to the first electrode 500a. The electrodes 500a, 500b and 500c may be printed using one or more of the AM printing methods mentioned. None of the electrodes 500a, 500b and 500c are in physical contact with one another at any point within the 3-electrode structure 500.

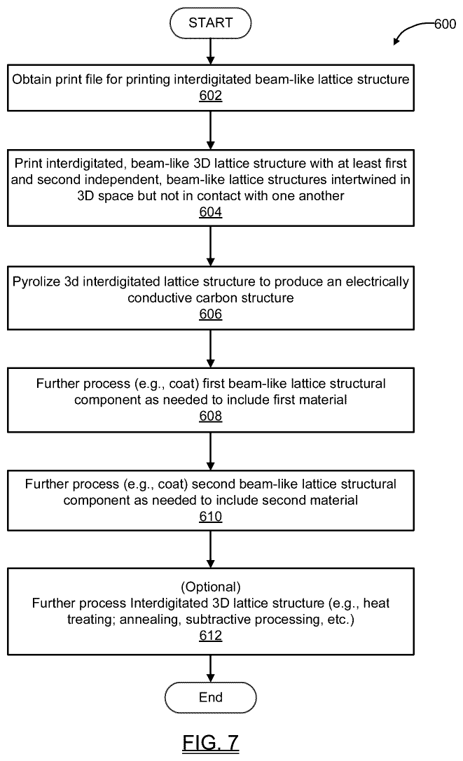

Referring now to FIG. 7, there is shown a high level flowchart 700 illustrating one example of a method in accordance with the present disclosure for producing an interpenetrating beam-like lattice structure. At operation 702 a print file (e.g., including G-code) may be obtained by the computer 14 for printing the interpenetrating beam-like lattice structure. The data for the print file may vary significantly depending on the specific AM printing system being used (e.g., SLS vs. projection microstereolithography). At operation 704 the AM printing system being used prints the interpenetrating, beam-like lattice structure with at least first and second independent beam-like lattice structures intertwined in 3D space, and further such that the two beam-like lattice structures are not in physical contact with one another at any point within the overall structure being printed.

At operation 706 the newly printed, interpenetrating, beam-like lattice structure is pyrolyzed to produce an electrically conductive carbon structure. At operation 708 the first beam-like lattice structural component of the overall structure may be further processed to include a first material. This processing may involve electrodeposition of another material (e.g., another metal) to fully plate or coat the first beam-like lattice structural component. At operation 710 a process may be performed on the second beam-like lattice structural component to fully plate or coat the second beam-like lattice structural component with a second material. Typically the second material will be a metal material as well. The first and second materials may be identical or they may differ. The specific plating or coating processes used on the two beam-like lattice structural components may be the same or may differ as well.

At operation 712 a final optional step may be further processing the newly plated or coated interpenetrating, beam-like lattice structure, such as, without limitation, performing a heat treating operation such annealing, performing a subtractive operation, etc.

The various embodiments of the present disclosure thus leverage computer aided design and advanced AM manufacturing techniques and processes to produce previously unachievable configurations by having two or more continuous electrode structures intertwining in 3D space. This provides a number of important benefits over previous electrode designs including, but not limited to, improved control electric field uniformity, the ability to carry out multiple electrochemical reactions, and an expanded design space for electrochemical devices.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A multi-electrode electrochemical apparatus, the apparatus comprising:
a first beam-like structure having a first material coating, the first beam-like structure forming a first electrode;
a second structure having a second material coating, the second structure forming a second electrode; and
the first and second structures being configured in an interpenetrating fashion within a defined 3D space to form an electrochemical apparatus, and without physical contact at any point within the defined 3D space.

2. The apparatus of claim 1, wherein the first beam-like structure comprises a beam-like lattice structure of interconnected beam-like elements.

3. The apparatus of claim 1, wherein the first beam-like structure comprises a plurality of parallel arranged beam-like elements interconnected at least at one end thereof.

4. The apparatus of claim 3, wherein the second structure comprises a plurality of curving, parallel arranged beam-like elements that wrap around ones of the beam-like elements of the first beam-like structure.

5. The apparatus of claim 4, wherein:
the plurality of parallel arranged beam-like elements of the first beam-like structure are coupled together at both of first and second opposing ends thereof; and
wherein the curving, parallel arranged beam-like elements are coupled together at opposing ends thereof.

6. The apparatus of claim 1, wherein the second structure also comprises a beam-like lattice structure.

7. The apparatus of claim 1, wherein the second structure comprises a triply periodic minimal surface.

8. The apparatus of claim 3, wherein the triply periodic minimal surface comprises a gyroid triply periodic minimal surface.

9. The apparatus of claim 8, further comprising a third beam-like lattice structure which is configured in an interpenetrating fashion with the first and second structures within the defined 3D volume, and not in contact with either of the first or second beam-like structures.

10. The apparatus of claim 1, wherein at least one of the first or second material coatings is metal.

11. The apparatus of claim 1, wherein at least one of the first or second material coatings is at least one of copper or nickel.

12. The apparatus of claim 1, wherein the first and second structures comprise are initially formed from polymer, then pyrolyzed, and then plated with the first and second materials.

13. The apparatus of claim 1, wherein:
the first structure forms a lattice-like structure with elements radiating out from a first axial center thereof;
the second structure forms a lattice-like structure with elements radiating out from a second axial center thereof, and where the second axial center is aligned with the first axial center; and
wherein the first and second structures form a disc-like electrochemical cell.

14. A method for forming a multi-electrode electrochemical apparatus using an additive manufacturing system, the method comprising:
printing first and second structures such that the first and second have portions thereof which form an interpenetrating configuration within a defined 3D volume, and without physically contacting one another within the defined 3D volume; and
plating the first and second structures with first and second materials, respectively.

15. The method of claim 14, wherein printing the first and second structures comprises printing at least one of the first and second structures as a beam-like structure having a plurality of interconnected beam-like elements forming a lattice structure.

16. The method of claim 14, wherein printing the first and second structures comprises printing at least one of the first and second structures as a triply periodic minimal surface structure.

17. The method of claim 14, wherein printing the first and second structures comprises printing the first structure as a structure having a plurality of parallel extending rods, and the second structure as a plurality of spiral curving rods which wrap around the plurality of parallel extending rods.

18. The method of claim 14, wherein the printing of the first and second beam-like structures comprises printing the first and second beam-like structures from a polymer.

19. The method of claim 18, further comprising pyrolyzing the first and second beam-like structures before plating the first and second beam-like structures with the first and second materials.

20. The method of claim 14, wherein plating the first and second beam-like structures comprises plating at least one of the first and second beam-like structures with a metal.
